(19) United States
(12) Patent Application Publication
(10) Pub. No.: US 2026/0223930 A1
(43) Pub. Date: Aug. 6, 2026

(54) HEATER AND MANUFACTURING METHOD THEREFOR, AND AEROSOL GENERATING DEVICE

(71) Applicant: SHENZHEN FIRST UNION TECHNOLOGY CO., LTD., Shenzhen, Guangdong (CN)

(72) Inventors: Wei CHEN, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/136,798

(22) PCT Filed: Nov. 22, 2023
(86) PCT No.: PCT/CN2023/133204

§ 371 Date: Jun. 6, 2025

(30) Foreign Application Priority Data
Dec. 8, 2022 (CN) 202211573350.8

(51) Int. Cl. A24F 40/46; H05B 3/46

(52) U.S. Cl. CPC A24F 40/46; H05B 3/46; H05B 2203/005; H05B 2203/032

(57) ABSTRACT

A heater and a manufacturing method therefor, and an aerosol generating device. The heater includes; a base body; an electric heating film layer provided on a surface of the base body; and an electrically conductive element, configured to feed electric power to the electric heating film layer and cause the flow direction of a current on the electric heating film laver to extend in the axial direction of the base body. The electrically conductive element includes at least one electrode extending in the axial direction of the base body. The electrode and the electric heating film layer are spaced apart.

### CROSS-REFERENCE TO RELATED APPLICATIONS

This application claims priority to Chinese Patent Application No. 202211573350.8, entitled “HEATER AND MANUFACTURING METHOD THEREFOR, AND AEROSOL GENERATING DEVICE” filed with the China National Intellectual Property Administration on Dec. 8, 2022, which is incorporated herein by reference in its entirety.

### TECHNICAL FIELD

This application relates to the field of electronic atomization technologies, and in particular, to a heater and a manufacturing method therefor, and an aerosol generating device.

### BACKGROUND

During use of smoking products (such as cigarettes or cigars), tobacco is burnt to produce smoke. Attempts have been made to replace these tobacco-burning products by making products that release compounds without burning. An example of the products is a heating and non-burning product that releases a compound by heating rather than burning a tobacco.

An existing aerosol generating device has problems that a resistance of an electric heating film layer is relatively large, and a heating rate of an aerosol forming substrate is relatively low, resulting in low usage experience of users.

### SUMMARY

This application provides a heater and a manufacturing method therefor, and an aerosol generating device, and aims to solve problems in an existing aerosol generating device that a resistance of an electric heating film layer is relatively large, and a heating rate of an aerosol forming substrate is relatively low.

According to an aspect of this application, a heater is provided and is configured to heat an aerosol forming substrate in an aerosol generation product to generate an aerosol; the heater includes:
a base body;
an electric heating film layer, arranged on a surface of the base body;
an electrically conductive element, configured to feed electric power to the electric heating film layer and cause a flow direction of a current on the electric heating film layer to extend in an axial direction of the base body,
where the electrically conductive element includes at least one electrode extending in an axial direction of the base body, and the electrode and the electric heating film layer are spaced apart.

According to another aspect of this application, a manufacturing method for the heater is provided. Spacing between the electrode and the electric heating film layer is implemented by at least one of the following:
applying the electrically conductive element and the electric heating film layer to a surface of the base body, and then removing a part of the electric heating film layer close to the electrode from the coated electric heating film layer;
first, applying the electric heating film layer to the surface of the base body, then, removing the electric heating film layer from a part of the surface, and finally, applying the electrically conductive element to the part of the surface;
partially applying the electrically conductive element to a first part of the surface of the base body, and completely applying the electric heating film layer on a second part of the surface of the base body; or, completely applying the electrically conductive element to the first part of the surface of the base body, and partially applying the electric heating film layer to the second part of the surface of the base body; or, partially applying the electrically conductive element to the first part of the surface of the base body, and partially applying the electric heating film layer to the second part of the surface of the base body; and
applying the electrically conductive element to the first part of the surface of the base body, and applying the electric heating film layer to the second part of the surface of the base body, where the first part of the surface and the second part of the surface are spaced apart.

According to another aspect of this application, an aerosol generating device is further provided, including:
a housing assembly;
the heater, where the heater is arranged in the housing assembly; and
a battery cell, configured to provide electric power.

According to the heater and the manufacturing method therefor, and the aerosol generating device, by means of feeding the electric power to the electric heating film layer by means of the at least one electrode, which extends in the axial direction of the base body and is spaced apart from the electric heating film layer, the flow direction of the current on the electric heating film layer extends in the axial direction of the base body. In this way, resistance of the electric heating film layer is reduced, and a heating rate of an aerosol forming substrate is increased, thereby improving usage experience of users.

### BRIEF DESCRIPTION OF THE DRAWINGS

One or more embodiments are exemplarily described with reference to corresponding accompanying drawings, and these exemplary descriptions do not construe a limitation to the embodiments. Elements having same reference numerals in the accompanying drawings represent similar elements, and unless otherwise particularly stated, figures in the accompanying drawings are not drawn to scale.

FIG. 1 is a schematic diagram of an aerosol generating device according to an implementation of this application;

FIG. 2 is an exploded view of an aerosol generating device according to an implementation of this application;

FIG. 3 is a schematic diagram of a first heater according to an implementation of this application;

FIG. 4 is an expanded planar schematic diagram of a first heater according to an implementation of this application;

FIG. 5 is a schematic diagram of a manufacturing method for a first heater according to an implementation of this application;

FIG. 6 is a schematic diagram of a second heater according to an implementation of this application;

FIG. 7 is an expanded planar schematic diagram of a second heater according to an implementation of this application;

FIG. 8 is a schematic diagram of a third heater according to an implementation of this application;

FIG. 9 is an expanded planar schematic diagram of a third heater according to an implementation of this application;

FIG. 10 is a schematic diagram of a fourth heater according to an implementation of this application;

FIG. 11 is an expanded planar schematic diagram of a fourth heater according to an implementation of this application;

FIG. 12 is a schematic diagram of a fifth heater according to an implementation of this application;

FIG. 13 is an expanded planar schematic diagram of a fifth heater according to an implementation of this application;

FIG. 14 is an expanded planar schematic diagram of a sixth heater according to an implementation of this application; and

FIG. 15 is a schematic diagram of a seventh heater according to an implementation of this application.

### DETAILED DESCRIPTION

To facilitate understanding of this application, this application is described in more detail below with reference to accompanying drawings and specific implementations. It is to be noted that, when an element is expressed as “being fixed to” another element, the element may be directly on the another element, or one or more intermediate elements may exist between the element and the another element. When one component is expressed as “being connected to” another component, the component may be directly connected to the another component, or one or more intermediate components may exist between the component and the another component. Terms “upper”, “lower”, “left”, “right”, “inner”, “outer”, and similar expressions used in this specification are only used for an illustrative purpose.

Unless otherwise defined, meanings of all technical and scientific terms used in this specification are the same as those usually understood by a person skilled in the technical field to which this application belongs. Terms used in this specification of this disclosure herein are merely intended to describe objectives of the specific implementations, but are not intended to limit this application. The term “and/or” used in this specification includes any or all combinations of one or more related listed items.

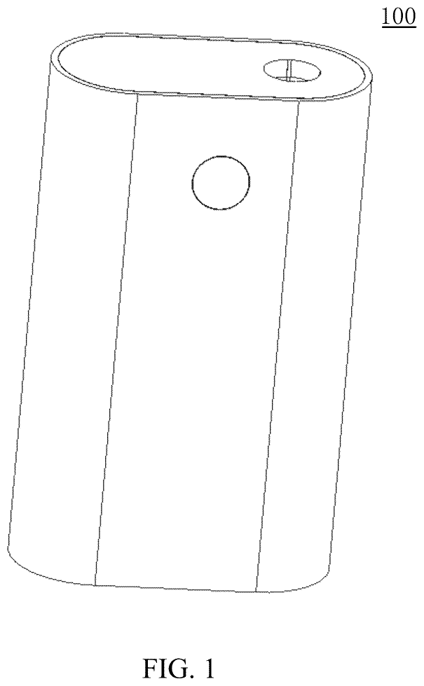

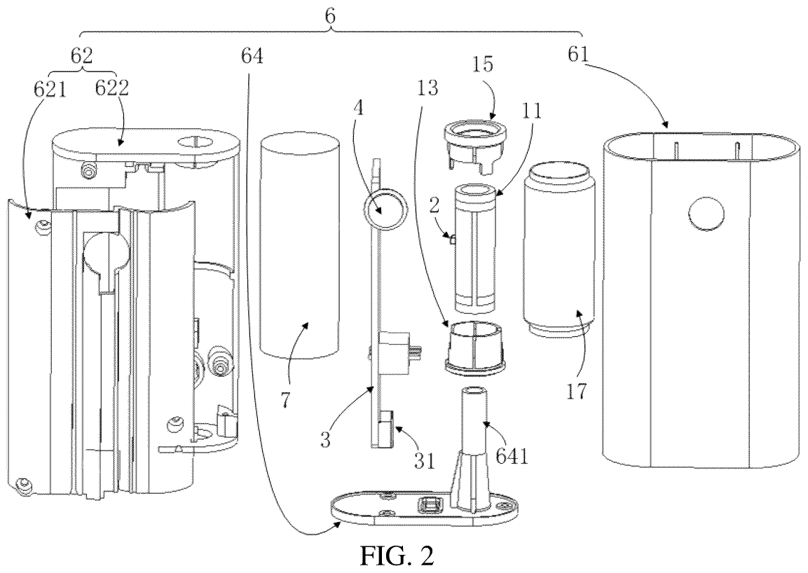

FIG. 1 and FIG. 2 show an aerosol generating device 100 according to an implementation of this embodiment. The aerosol generating device 100 includes a housing assembly 6 and a heater 11. The heater 11 is arranged in the housing assembly 6.

The housing assembly 6 includes a housing 61, a fixed housing 62, a base, and a bottom cap 64. Both the fixed housing 62 and the base are fixed in the housing 61. The base is configured to fix the heater 11. The base is arranged in the fixed housing 62. The bottom cap 64 is arranged at one end of the housing 61 and covers the housing 61.

The base includes a base 15 arranged at a near end of the heater 11 and a base 13 arranged at a far end of the heater 11. Both the base 15 and the base 13 are arranged in the fixed housing 62. An air inlet tube 641 is protruded from the bottom cap 64. One end of the base 13 away from the base 15 is connected to the air inlet tube 641. The base 15, the heater 11, the base 13, and the air inlet tube 641 are coaxially arranged. In addition, the heater 11 and the base 15 as well as the base 13 are sealed by seal members, the base 13 and the air inlet tube 641 are sealed, and the air inlet tube 641 is communicated with outside air to facilitate smooth air inlet during smoking of a user.

The aerosol generating device 100 further includes a circuit 3 and a battery cell 7. The fixed housing 62 includes a front housing 621 and a rear housing 622, the front housing 621 is fixedly connected to the rear housing 622, both the circuit 3 and the battery cell 7 are arranged in the fixed housing 62, the battery cell 7 is electrically connected to the circuit 3, a button 4 is protruded from the housing 61, and power on or off of the electric heating film layer on the heater 11 can be implemented by pressing the button 4. The electric heating film layer includes an electric heating coating, preferably, an infrared electric heating coating that can radiate an infrared ray. The circuit 3 is further connected to a charging interface 31, the charging interface 31 is exposed on the bottom cap 64, and a user may charge or upgrade the aerosol generating device 100 through the charging interface 31, to ensure continuous use of the aerosol generating device 100.

The aerosol generating device 100 further includes a heat insulation tube 17, the heat insulation tube 17 is arranged in the fixed housing 62, the heat insulation tube 17 is arranged on a periphery of the heater 11, and the heat insulation tube 17 can prevent a large amount of heat from being transferred to the housing 61 to enable the user to feel hot on a hand. The heat insulation tube includes a heat insulation material. The heat insulation material may be a heat insulation adhesive, aerogel, an aerogel blanket, asbestos, aluminum silicate, calcium silicate, diatomite, zirconia, and the like. The heat insulation tube 17 may alternatively be a vacuum heat insulation tube. An infrared reflective coating may alternatively be formed on the heat insulation tube 17, to reflect part heat radiated by the heater 11 back to the heater 11, thereby improving heating efficiency.

The aerosol generating device 100 further includes a temperature sensor 2, for example, a Negative Temperature Coefficient (NTC) thermistor, a Positive Temperature Coefficient (PCT) thermistor or a thermocouple, configured to detect a real-time temperature of the heater 11 and transmit the detected real-time temperature to the circuit 3. The circuit 3 adjusts a magnitude of a current flowing through the heater 11 based on the real-time temperature.

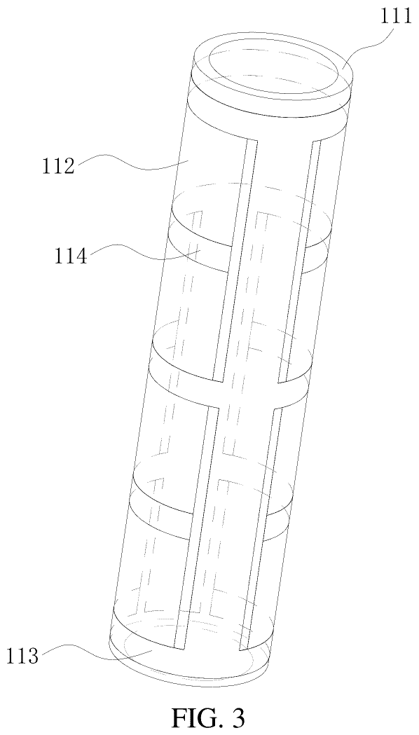

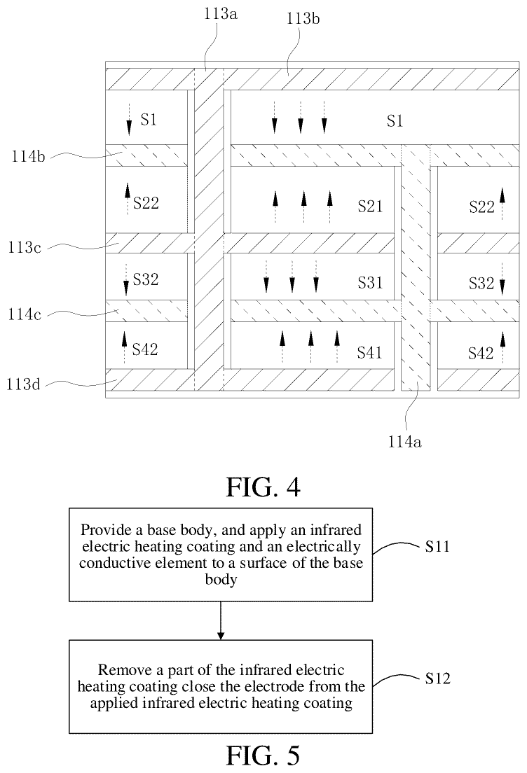

FIG. 3 and FIG. 4 show a heater according to a first example of this application. As shown in FIG. 3 and FIG. 4, the heater 11 includes:
a base body 111, which is internally provided with a chamber suitable for accommodating an aerosol forming substrate.

Specifically, the base body 111 includes a near end, a far end, and a surface extending between the near end and the far end. The base body 111 is internally hollow to form the chamber. The base body 111 may be in a shape of a tube, for example, a cylinder, a prism, or another column. The base body 111 is preferably in the shape of the cylinder, and the chamber is a cylindrical hole that penetrates through a middle part of the base body 111.

In an example, an inside diameter of the base body 111 ranges from 6 mm to 15 mm, or ranges from 7 mm to 15 mm, or ranges from 7 mm to 14 mm, or ranges from 7 mm to 12 mm, or ranges from 7 mm to 10 mm. An axial extension length of the base body 111 ranges from 15 mm to 30 mm, or ranges from 15 mm to 28 mm, or ranges from 15 mm to 25 mm, or ranges from 16 mm to 25 mm, or ranges from 18 mm to 25 mm, or ranges from 18 mm to 24 mm, or ranges from 18 mm to 22 mm. The base body 111 in this size is suitable for a thick and short aerosol generation product.

In an example, an inside diameter of the base body 111 ranges from 5 mm to 5.9 mm, and may be 5.5 mm, 5.4 mm, or the like in a specific example. An axial extension length of the base body 111 ranges from 30 mm to 60 mm, or ranges from 30 mm to 55 mm, or ranges from 30 mm to 50 mm, or ranges from 30 mm to 45 mm, or ranges from 30 mm to 40 mm. The base body 111 in this size is suitable for a thin and long aerosol generation product.

The base body 111 may be made of a material that is high-temperature resistant and can transmit an infrared ray, such as quartz glass, ceramic, or mica, or may be made of another material having high infrared-ray transmittance, for example: a high-temperature-resistant material having an infrared-ray transmittance of over 95%. This is not specifically limited here.

The aerosol forming substrate is a substrate that can release a volatile compound that can form an aerosol. The volatile compound may be released by heating the aerosol forming substrate. The aerosol forming substrate may be solid, or liquid, or components including solid and liquid. The aerosol forming substrate may be loaded onto a carrier or a support through adsorption, applying, or impregnation, or in another manner. The aerosol forming substrate may conveniently be a part of an aerosol generation product.

The aerosol forming substrate may include nicotine. The aerosol forming substrate may include tobaccos, for example, may include a tobacco-containing material including volatile compounds with a tobacco aroma. The volatile compounds with a tobacco aroma are released from the aerosol forming substrate when the aerosol forming substrate is heated. The aerosol forming substrate may include at least one aerosol forming agent. The aerosol forming agent may be any suitable known compound or a mixture of compounds. During use, the compound or the mixture of compounds facilitates dense and stable aerosol formation, and is substantially resistant to thermal degradation at an operating temperature of an aerosol generating system. Suitable aerosol forming agents are well known in the related art, including but not limited to: polyols such as triethylene glycol, 1,3-butanediol, and glycerol; esters of the polyols such as glyceryl monoacetate, glyceryl diacetate, or glyceryl triacetate; and fatty acid ester of monobasic carboxylic acid, dibasic carboxylic acid, or polybasic carboxylic acid such as dimethyl dodecane dibasic ester and dimethyl tetradecane dibasic ester.

The infrared electric heating coating 112 generates heat under electric power, to generate an infrared ray with a specific wavelength, for example: a far infrared ray ranging from 8 μm to 15 μm penetrate through the based body 111 to heat the aerosol forming substrate in the chamber. When a wavelength of the infrared ray matches an absorption wavelength of the aerosol forming substrate, energy of the infrared ray is easily absorbed by the aerosol forming substrate.

The infrared electric heating coating 112 is preferably formed by fully and uniformly mixing far infrared electric heating ink, ceramic powder, and an inorganic adhesive, and is then applied to an outer surface of the base body 111. After being dried and cured for a period of time, a thickness of the infrared electric heating coating 112 ranges from 30 μm to 50 μm. Certainly, the infrared electric heating coating 112 may further be formed by mixing and stirring stannic chloride, tin oxide, antimony butter, titanium tetrachloride, and anhydrous cupric sulfate according to a specific ratio, and is then applied to the outer surface of the base body 111. Or, the infrared electric heating coating may be one of a silicon carbide ceramic layer, a carbon fiber composite layer, a zirconium-titanium oxide ceramic layer, a zirconium-titanium nitride ceramic layer, a zirconium-titanium boride ceramic layer, a zirconium-titanium carbide ceramic layer, a ferric oxide ceramic layer, a ferric nitride ceramic layer, a ferric boride ceramic layer, a ferric carbide ceramic layer, a rare-earth oxide ceramic layer, a rare-earth nitride ceramic layer, a rare-earth boride ceramic layer, a rare-earth carbide ceramic layer, a nickel-cobalt oxide ceramic layer, a nickel-cobalt nitride ceramic layer, a nickel-cobalt boride ceramic layer, a nickel-cobalt carbide ceramic layer, or a high silica molecular sieve ceramic layer. The infrared electric heating coating 112 may alternatively be an existing coating made of another material.

The infrared electric heating coating 112 is formed on a surface of the base body 111. The infrared electric heating coating 112 may be formed on the outer surface of the base body 111, or may be formed on an inner surface of the base body 111.

In a preferred implementation, the infrared electric heating coating 112 is formed on the outer surface of the base body 111. In a direction from a near end of the base body 111 to a far end of the base body 111, that is, in an axial direction of the base body 111, the infrared electric heating coating 112 includes a first infrared electric heating coating S1, a second infrared electric heating coating (S21, S22), a third infrared electric heating coating (S31, S32), and a fourth infrared electric heating coating (S41, S42) that are spaced apart. The second infrared electric heating coating (S21, S22) includes an infrared electric heating coating S21 and an infrared electric heating coating S22 (a sub-infrared electric heating coating) that are spaced apart in a peripheral direction of the base body 111, the third infrared electric heating coating (S31, S32) includes an infrared electric heating coating S31 and an infrared electric heating coating S32 that are spaced apart in the peripheral direction of the base body 111, and the fourth infrared electric heating coating (S41, S42) includes an infrared electric heating coating S41 and an infrared electric heating coating S42 that are spaced part in the peripheral direction of the base body 111.

The electrically conductive element includes an electrode 113 and an electrode 114 which are spaced apart on the base body 111 and are configured to feed electric power provided by the battery cell 7 to the infrared electric heating coating 112.

Both the electrode 113 and the electrode 114 maintain in contact with the infrared electric heating coating 112 to form an electrical connection. The electrode 113 and the electrode 114 are both electrically conductive coatings. The electrically conductive coatings may be metal coatings. The metal coatings may include silver, gold, palladium, platinum, copper, nickel, molybdenum, tungsten, niobium, or an alloy material of the above metals.

The electrode 113 includes an electrode 113a that extends in the axial direction of the base body 111 and that has a strip shape, and an electrode 113b, an electrode 113c, and an electrode 113d that extend in the peripheral direction of the base body 111 and that have an arc shape, where the electrode 113b, the electrode 113c, and the electrode 113d are sequentially spaced apart in the axial direction of the base body 111.

The electrode 113a is spaced apart from the infrared electric heating coating 112. One end of the electrode 113a is arranged close to the near end of the base body 111, and the other end of the electrode 113a is arranged close to the far end of the base body 111. Preferably, the electrode 113a is spaced apart from the near end or the far end of the base body 111. A spacing distance ranges from 0 to 1 mm, which may be 0.2 mm, 0.4 mm, 0.5 mm, 0.7 mm, or the like in a specific example.

The electrode 113b is arranged close to the near end of the base body 111. The electrode 113b starts from the electrode 113a, extends in the peripheral direction of the base body 111, and ends at the electrode 113a. A peripheral extension length of the electrode 113b is greater than a peripheral extension length of the first infrared electric heating coating S1. The electrode 113b maintains in contact with the first infrared electric heating coating S1 to form an electrical connection.

The electrode 113c is arranged close to a middle part of the base body 111, and the electrode 113c is arranged between the second infrared electric heating coating (S21, S22) and the third infrared electric heating coating (S31, S32). The electrode 113c starts from the electrode 113a, a part of the electrode 113c extends in a first peripheral direction, for example, a clockwise direction, of the base body 111, and is arranged close to the electrode 114. This part of the electrode 113c maintains in contact with the infrared electric heating coating S22 and the infrared electric heating coating S32 to form an electrical connection. Another part of the electrode 113c extends in a second peripheral direction, for example, an anticlockwise direction, of the base body 111, and is arranged close to the electrode 114. This another part of the electrode 113c maintains in contact with the infrared electric heating coating S21 and the infrared electric heating coating S31 to form an electrical connection.

The electrode 113d is arranged close to the far end of the base body 111. The electrode 113d starts from the electrode 113a, a part of the electrode 113d extends in the first peripheral direction, for example, the clockwise direction, of the base body 111, and is arranged close to the electrode 114. This part of the electrode 113d maintains in contact with the infrared electric heating coating S42 to form an electrical connection. Another part of the electrode 113d extends in a second peripheral direction, for example, an anticlockwise direction, of the base body 111, and is arranged close to the electrode 114. This another part of the electrode 113d maintains in contact with the infrared electric heating coating S41 to form an electrical connection.

The electrode 114 includes an electrode 114a that extends in the axial direction of the base body 111 and that has a strip shape, and an electrode 114b and an electrode 114c that extend in the peripheral direction of the base body 111 and that have an arc shape, where the electrode 114b and the electrode 114c are sequentially spaced apart in the axial direction of the base body 111.

The electrode 114a is spaced apart from the second infrared electric heating coating (S21, S22), the third infrared electric heating coating (S31, S32), and the fourth infrared electric heating coating (S41, S42). The electrode 114a and the electrode 113a are spaced apart in the peripheral direction of the base body 111, that is, arranged on two sides of the infrared electric heating coatings S21, S31, and S41. An axial extension length of the electrode 114a is less than an axial extension length of the electrode 113a. One end of the electrode 114a is arranged close to the first infrared electric heating coating S1. Preferably, one end of the electrode 114a maintains in contact with the first infrared electric heating coating S1; and the other end of the electrode 114a is arranged close to the far end of the base body 111.

The electrode 114b is arranged between the first infrared electric heating coating S1 and the second infrared electric heating coating (S21 and S22), or is arranged between the electrode 113b and the electrode 113c. The electrode 114b starts from the electrode 114a, a part of the electrode 114b extends in a first peripheral direction, for example, a clockwise direction, of the base body 111, and is arranged close to the electrode 113a. This part of the electrode 114b maintains in contact with the infrared electric heating coating S1 and the infrared electric heating coating S21 to form an electrical connection. Another part of the electrode 114b extends in a second peripheral direction, for example, an anticlockwise direction, of the base body 111, and is arranged close to the electrode 113a. This another part of the electrode 114b maintains in contact with the infrared electric heating coating S1 and the infrared electric heating coating S22 to form an electrical connection.

The electrode 114c is arranged between the third infrared electric heating coating (S31, S32) and the fourth infrared electric heating coating (S41, S42). The electrode 114c starts from the electrode 114a, a part of the electrode 114c extends in a first peripheral direction, for example, a clockwise direction, of the base body 111, and is arranged close to the electrode 113a. This part of the electrode 114c maintains in contact with the infrared electric heating coating S31 and the infrared electric heating coating S41 to form an electrical connection. Another part of the electrode 114c extends in a second peripheral direction, for example, an anticlockwise direction, of the base body 111, and is arranged close to the electrode 113a. This another part of the electrode 114c maintains in contact with the infrared electric heating coating S32 and the infrared electric heating coating S42 to form an electrical connection.

After the electrode 113 and the electrode 114 conduct electricity, the electrode 113 and the electrode 114 simultaneously feed the electric power provided by the battery cell 7 to the first infrared electric heating coating S1, the second infrared electric heating coating (S21, S22), a third infrared electric heating coating (S31, S32), and a fourth infrared electric heating coating (S41, S42). That is, the first infrared electric heating coating S1, the second infrared electric heating coating (S21, S22), the third infrared electric heating coating (S31, S32), and the fourth infrared electric heating coating (S41, S42) are equivalent to being connected in parallel between the electrode 113 and the electrode 114. The infrared electric heating coating S21 and the infrared electric heating coating S22, the infrared electric heating coating S31 and the infrared electric heating coating S32, and the infrared electric heating coating S41 and the infrared electric heating coating S42 are connected in parallel between the electrode 113 and the electrode 114. By means of the plurality of infrared electric heating coatings that are connected in parallel, a resistance of the infrared electric heating coating 112 can be reduced as a whole. Assuming that a current flows in from the electrode 113 and flows out from the electrode 114, a flow direction of the current on the infrared electric heating coating 112 basically extends in the axial direction of the base body 111 (as shown by a dashed arrow in the figure). Flow directions of currents on the first infrared electric heating coating S1 and the third infrared electric heating coating (S31, S32) are the same as an extension direction from the near end of the base body 111 to the far end of the base body 111. Flow directions of currents on the second infrared electric heating coating (S21, S22) and the fourth infrared electric heating coating (S41, S42) are the same as an extension direction from the far end of the base body 111 to the near end of the base body 111. Flow directions of currents on adjacent infrared electric heating coatings are opposite.

It may be understood that, a quantity of the plurality of infrared electric heating coatings that are connected in parallel is not limited to that shown in FIG. 3 and FIG. 4, and may be increased or decreased.

An equivalent resistance of each of the plurality of infrared electric heating coatings that are connected in parallel may be the same, or may be partially the same, or may be different from each other. Similarly, heating power of each infrared electric heating coating may be the same, may be partially the same, or may be different from each other. Power distribution of each area may be adjusted by adjusting an equivalent resistance of each infrared electric heating coating, so as to adjust temperature distribution of each area.

In a preferred implementation, an equivalent resistance of the first infrared electric heating coating S1 is relatively low, a heat power thereof is relatively high, and a heat speed thereof is relatively high. In this way, a temperature of part aerosol forming substrate corresponding to the first infrared electric heating coating S1 may rapidly increase and generate a smokable aerosol relative to part aerosol forming substrate corresponding to another infrared electric heating coating, thereby shortening a preheat time of the aerosol forming substrate, and reducing a smoking waiting time. Equivalent resistances of the second infrared electric heating coating (S21, S22), the third infrared electric heating coating (S31, S32), and the fourth infrared electric heating coating (S41, S42) may be the same.

It is to be noted that, a heating speed of the first infrared electric heating coating S1 is higher than that of another infrared electric heating coating, for example, the second infrared electric heating coating (S21, S22).

This may be verified in the following manner: The same preset temperature is set. When a heating temperature of the first infrared electric heating coating S1 reaches the preset temperature from an initial temperature (for example, an ambient temperature), if a heating temperature of the second infrared electric heating coating (S21, S22) is lower than the preset temperature, it may be indicated that the heating speed of the first infrared electric heating coating S1 is higher than the heating speed of the second infrared electric heating coating (S21, S22). The preset temperature may be a maximum temperature of the aerosol generating device 100, or may be an operating temperature, that is, a temperature at which an aerosol forming substrate generates an aerosol.

Due to differences in equivalent resistance, heating power, or heating speed, in a preheat stage of the aerosol generating device 100, there is a difference or a significant difference between temperatures of different infrared electric heating coatings. However, in a heat preservation stage or a smoking stage of the aerosol generating device 100, there may be a slight difference between the temperatures of the different infrared electric heating coatings. The preheat stage, the temperature preservation stage, or the smoking stage are different duration periods in a curve of a temperature of an aerosol forming product or an infrared electric heating coating changing along with time.

It is to be noted that, according to a calculation formula R=ρL/S of a resistance, when specific resistivity ρ is specific (when the infrared electric heating coating is uniformly applied, the resistivity ρ is specific), a resistance of a resistor depends on values of parameters L and S. Therefore, the equivalent resistance of each infrared electric heating coating may be adjusted by setting two parameters L, S of the infrared electric heating coating.

It is to be noted that, in examples in FIG. 3 and FIG. 4, an arrangement of the electrode 113 and the electrode 114 facilitates routing with the battery cell 7. For example: a first wire electrically connected to the electrode 113, and a second wire electrically connected to the electrode 114. One end of the first wire and one end of the second wire may be arranged at the far end of the base body 111, and the other end of the first wire and the other end of the second wire may be electrically connected to the battery cell 7. Certainly, it is alternatively feasible that one end of the first wire is arranged at the far end of the base body 111 and one end of the second wire is arranged at the near end of the base body 111.

It is to be noted that, in the examples in FIG. 3 and FIG. 4, the base body 111 is further provided with a positioning slot. In a preferred implementation, the positioning slot is provided at the far end of the base body 111, for example, is formed by recessing of a partial portion of the far end of the base body 111. The positioning slot may be configured to position the base body 111, for example: during assembly, a bump on the base body 13 matches the positioning slot, so as to hold the far end of the base body 111. When a heater 11 is manufactured, information such as orientations or endpoints for applying the electric heating film layer and the electrode may be determined by matching a preparation tool and the positioning slot, which facilitates applying the electric heating film layer and the electrode and improving manufacturing efficiency.

It is to be noted that, the electrode 113a is spaced apart from the infrared electric heating coating 112, and the electrode 114a is spaced apart from the second infrared electric heating coating (S21, S22), the third infrared electric heating coating (S31, S32), and the fourth infrared electric heating coating (S41, S42). This may be implemented by using at least one of the following:
first, applying an electrically conductive element to a surface of the base body 111; then, applying an electric heating film layer to the surface of the base body 111; finally, removing a part of the electric heating film layer close to the electrode 113a and the electrode 114a from the applied electric heating film layer;
first, applying the electric heating film layer to the surface of the base body 111, then, applying the electrically conductive element to the surface of the base body 111, and finally, removing the part of the electric heating film layer close to the electrode 113a and the electrode 114a;
first, applying the electric heating film layer to the surface of the base body 111, then, removing the electric heating film layer from part surface, and finally, partially applying the electrically conductive element to the part of the surface; (partially applying refers to that the electrically conductive element or the electric heating film layer are not fully applied to a corresponding surface, and the following is similar)
partially applying the electrically conductive element to a first part of the surface of the base body 111, and completely applying the electric heating film layer to a second part of the surface of the base body 111; or, completely applying the electrically conductive element to the first part of the surface of the base body 111, and partially applying the electric heating film layer to the second part of the surface of the base body 111; or, partially applying the electrically conductive element to the first part of the surface of the base body 111, and partially applying the electric heating film layer to the second part of the surface of the base body 111; (completely applying refers to that the electrically conductive element or the electric heating film layer is fully applied to the corresponding surface)
applying the electrically conductive element to the first part of the surface of the base body 111, and applying the electric heating film layer to the second part of the surface of the base body 111, where the first part of the surface and the second part of the surface are spaced apart.

For ease of understanding, the following describes a manufacturing method for the heater 11 in the examples in FIG. 3 and FIG. 4 with reference to one spacing manner.

As shown in FIG. 5, a manufacturing method for a heater 11 includes:
Step S11: Provide a base body 111, and apply an infrared electric heating coating and an electrically conductive element to a surface of the base body 111.

In this step, the infrared electric heating coating may be first applied, and then the electrically conductive element is applied. Alternatively, the electrically conductive element may be first applied, and then the infrared electric heating coating is applied. A shape of the electrically conductive element is applied according to the examples in FIG. 3 and FIG. 4. The infrared electric heating coating is applied in a peripheral direction of the base body 111, and an upper end and a lower end of the infrared electric heating coating are spaced apart from an end portion of the base body 111.
Step S12: Remove a part of the infrared electric heating coating close to the electrode 113a and the electrode 114a from the applied infrared electric heating coating.

In this step, the part of the infrared electric heating coating close to the electrode 113a and the electrode 114a need to be removed from the applied infrared electric heating coating, so as to form the first infrared electric heating coating S1, the second infrared electric heating coating (S21, S22), the third infrared electric heating coating (S31, S32), and the fourth infrared electric heating coating (S41, S42) shown in FIG. 3 or FIG. 4.

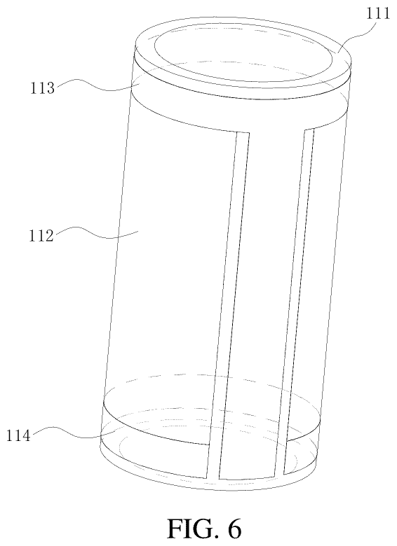

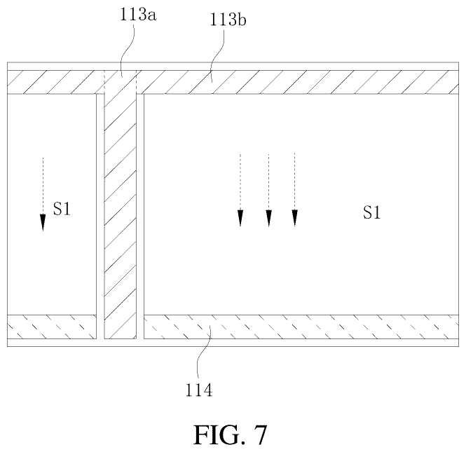

FIG. 6 and FIG. 7 show a heater according to a second example of this application.

In examples in FIG. 6 and FIG. 7, the infrared electric heating coating 112 includes a first infrared electric heating coating S1. The first infrared electric heating coating S1 is not separated into other infrared electric heating coatings.

The electrode 113 includes an electrode 113a that extends in an axial direction of the base body 111 and that has a strip shape, and an electrode 113b that extends in a peripheral direction of the base body 111 and that has an arc shape.

Similar to the examples in FIG. 3 and FIG. 4, the electrode 113a is spaced apart from the first infrared electric heating coating S1. One end of the electrode 113a is arranged close to the near end of the base body 111, and the other end of the electrode 113a is arranged close to the far end of the base body 111. The electrode 113b is arranged close to the near end of the base body 111. The electrode 113b starts from the electrode 113a, extends in the peripheral direction of the base body 111, and ends at the electrode 113a. A peripheral extension length of the electrode 113b is greater than a peripheral extension length of the first infrared electric heating coating S1. The electrode 113b maintains in contact with the first infrared electric heating coating S1 to form an electrical connection.

Different from the examples in FIG. 3 and FIG. 4, the electrode 114 is configured to extend in a peripheral direction of the base body 111 and have an arc shape. The electrode 114 is arranged close to the far end of the base body 111. A peripheral extension length of the electrode 114 is the same as the peripheral extension length of the first infrared electric heating coating S1. The electrode 114 maintains in contact with the first infrared electric heating coating S1 to form an electrical connection.

Different from the examples in FIG. 3 and FIG. 4, an inside diameter of the base body 111 ranges from 6 mm to 15 mm, or ranges from 7 mm to 15 mm, or ranges from 7 mm to 14 mm, or ranges from 7 mm to 12 mm, or ranges from 7 mm to 10 mm. An axial extension length of the base body 111 ranges from 15 mm to 30 mm, or ranges from 15 mm to 28 mm, or ranges from 15 mm to 25 mm, or ranges from 16 mm to 25 mm, or ranges from 18 mm to 25 mm, or ranges from 18 mm to 24 mm, or ranges from 18 mm to 22 mm. The base body 111 in this size is suitable for a thick and short aerosol generation product.

From a calculation formula R=ρL/S of a resistance, for the infrared electric heating coating 112 on which a flow direction of a current basically extends in the axial direction of the base body 111 relative to the infrared electric heating coating on which a flow direction of a current basically extends in the peripheral direction of the base body 111, a value of a parameter L is decreased and a value of a parameter S increased. Therefore, the heater in the examples in FIG. 6 and FIG. 7 can reduce the resistance of the infrared electric heating coating 112. Like the examples in FIG. 3 and FIG. 4, the resistance of the infrared electric heating coating 112 may be further reduced by connecting a plurality of infrared electric heating coatings in parallel.

Similar to the examples in FIG. 3 and FIG. 4, an arrangement of the electrode 113 and the electrode 114 facilitates routing with the battery cell 7.

It is to be noted that, in the examples in FIG. 6 and FIG. 7, for same numbered components as those in the examples in FIG. 3 and FIG. 4, and other unstated content, refer to the foregoing content. The following examples are similar.

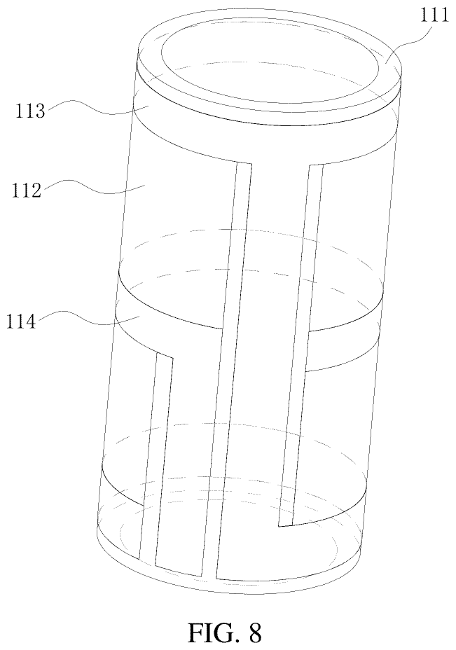

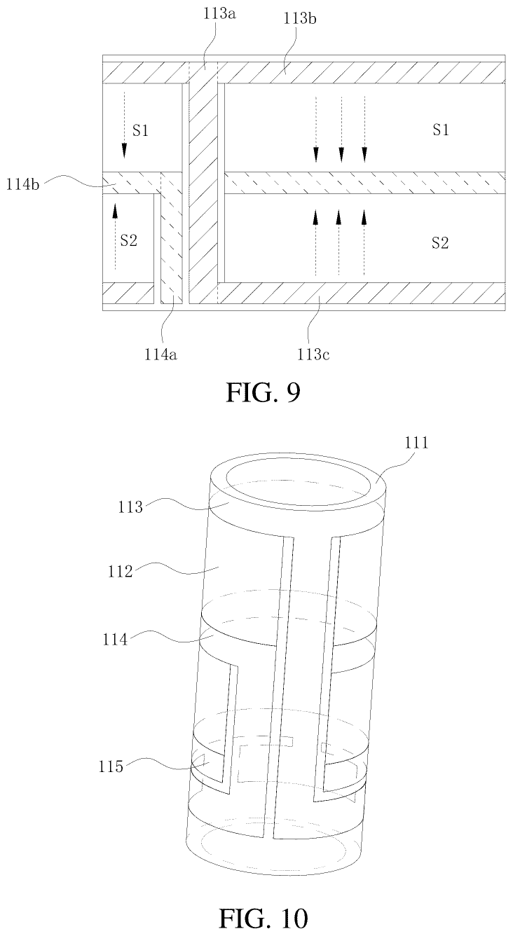

FIG. 8 and FIG. 9 show a heater according to a third example of this application.

In the examples in FIG. 8 and FIG. 9, a size of the base body 111 may be designed to be applicable to a thick and short aerosol generating product or a thin and long aerosol generating product. Preferably, the base body 111 is designed according to a size applicable to a thick and short aerosol generating product, that is, an inside diameter of the base body 111 ranges from 6 mm to 15 mm, or ranges from 7 mm to 15 mm, or ranges from 7 mm to 14 mm, or ranges from 7 mm to 12 mm, or ranges from 7 mm to 10 mm. An axial extension length of the base body 111 ranges from 15 mm to 30 mm, or ranges from 15 mm to 28 mm, or ranges from 15 mm to 25 mm, or ranges from 16 mm to 25 mm, or ranges from 18 mm to 25 mm, or ranges from 18 mm to 24 mm, or ranges from 18 mm to 22 mm.

In examples in FIG. 8 and FIG. 9, the infrared electric heating coating 112 includes a first infrared electric heating coating S1 and a second infrared electric heating coating S2, and the second infrared electric heating coating S2 is separated into other infrared electric heating coatings.

The electrode 113 includes an electrode 113a that extends in an axial direction of the base body 111 and that has a strip shape, and electrodes 113b and 113c that extend in a peripheral direction of the base body 111 and that have an arc shape.

Similar to the examples in FIG. 3 and FIG. 4, the electrode 113a is spaced apart from the first infrared electric heating coating S1 and the second infrared electric heating coating S2. One end of the electrode 113a is arranged close to the near end of the base body 111, and the other end of the electrode 113a is arranged close to the far end of the base body 111. The electrode 113b is arranged close to the near end of the base body 111. The electrode 113b starts from the electrode 113a, extends in the peripheral direction of the base body 111, and ends at the electrode 113a. A peripheral extension length of the electrode 113b is greater than a peripheral extension length of the first infrared electric heating coating S1. The electrode 113b maintains in contact with the first infrared electric heating coating S1 to form an electrical connection.

Different from examples in FIG. 3 and FIG. 4, the electrode 113c is arranged close to the far end of the base body 111. One end of the electrode 113c starts from the electrode 113a, and the other end of the electrode 113c extends in a second peripheral direction, that is, an anticlockwise direction, of the base body 111, and is arranged close to the electrode 114. The electrode 113c maintains in contact with the second infrared electric heating coating S2 to form an electrical connection.

The electrode 114 includes an electrode 114a that extends in an axial direction of the base body 111 and that has a strip shape, and an electrode 114b that extends in a peripheral direction of the base body 111 and that has an arc shape.

Different from the examples in FIG. 3 and FIG. 4, the electrode 114a is arranged close to the electrode 113a. A spacing distance between the electrode 114a and the electrode 113a ranges from 0 to 1 mm, which may be 0.2 mm, 0.4 mm, 0.5 mm, 0.7 mm, or the like in a specific example.

Different from the examples in FIG. 3 and FIG. 4, the electrode 114b is arranged between the first infrared electric heating coating S1 and the second infrared electric heating coating S2. One end of the electrode 114b starts from the electrode 114a, and the other end of the electrode 114b extends in a first peripheral direction, that is, a clockwise direction, of the base body 111, and is arranged close to the electrode 113a. The electrode 114b maintains in contact with the first infrared electric heating coating S1 and the second infrared electric heating coating S2 to form an electrical connection.

Similar to the examples in FIG. 3 and FIG. 4, after the electrode 113 and the electrode 114 conduct electricity, the electrode 113 and the electrode 114 simultaneously feed the electric power provided by the battery cell 7 to the first infrared electric heating coating S1 and the second infrared electric heating coating S2. That is, the first infrared electric heating coating S1 and the second infrared electric heating coating S2 are equivalent to being connected in parallel between the electrode 113 and the electrode 114. Assuming that a current flows in from the electrode 113 and flows out from the electrode 114, a flow direction of the current on the infrared electric heating coating 112 basically extends in the axial direction of the base body 111 (as shown by a dashed arrow in the figure). Therefore, a resistance of the infrared electric heating coating 112 can be reduced. Further, by means of the plurality of infrared electric heating coatings that are connected in parallel, a resistance of the infrared electric heating coating 112 can further be reduced as a whole.

Similar to the examples in FIG. 3 and FIG. 4, an arrangement of the electrode 113 and the electrode 114 facilitates routing with the battery cell 7. The resistance of the infrared electric heating coating 112 may be reduced as a whole. Power distribution of each area may be adjusted by adjusting an equivalent resistance of each infrared electric heating coating, so as to adjust temperature distribution of each area.

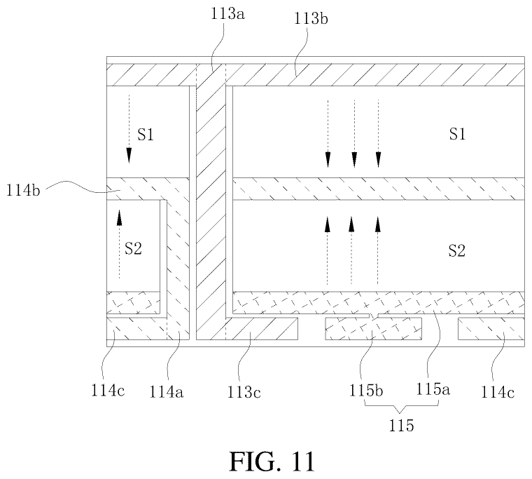

FIG. 10 and FIG. 11 show a heater according to a fourth example of this application.

In the examples in FIG. 10 and FIG. 11, a size of the base body 111 may be designed to be applicable to a thick and short aerosol generating product or a thin and long aerosol generating product, preferably, designed to be applicable to the thick and short aerosol generating product.

Different from the examples in FIG. 8 and FIG. 9, the electrically conductive element further includes an electrode 115 spaced apart on the base body 111.

Different from the examples in FIG. 8 and FIG. 9, one end of the electrode 113c starts from the electrode 113a, and the other end of the electrode 113c extends in a second peripheral direction, that is, an anticlockwise direction, of the base body 111, and is arranged close to the electrode 115. The electrode 113c is spaced apart from the second infrared electric heating coating S2.

Different from the examples in FIG. 8 and FIG. 9, the electrode 114 further includes an electrode 114c that extends in a peripheral direction of the base body 111 and has an arc shape. One end of the electrode 114c starts from the electrode 114a, and the other end of the electrode 114c extends in a first peripheral direction, that is, a clockwise direction, of the base body 111, and is arranged close to the electrode 115. The electrode 114c is spaced apart from the second infrared electric heating coating S2.

The electrode 115 includes an electrode 115a and an electrode 115b that extend in the peripheral direction of the base body 111 and have an arc shape. The electrode 115a maintains in contact with the second infrared electric heating coating S2 to form an electrical connection, and a peripheral extension length of the first electrode 115a is the same as the peripheral extension length of the second infrared electric heating coating S2. The electrode 115b is connected to the electrode 115a, and a peripheral extension length of the electrode 115b is less than the peripheral extension length of the electrode 115a.

Similar to the examples in FIG. 8 and FIG. 9, an arrangement of the electrode 113, the electrode 114, and the electrode 115 facilitates routing with the battery cell 7.

Relative to an infrared electric heating coating on which a flow direction of a current basically extends basically in a peripheral direction of the base body 111, an equivalent resistance of the infrared electric heating coating illustrated in FIG. 10 and FIG. 11 is relatively low.

Similar to the examples in FIG. 8 and FIG. 9, electric power may be simultaneously fed to the infrared electric heating coatings by controlling the electrode 113, the electrode 114, and the electrode 115 to conduct electricity. After the electrode 113, the electrode 114, and the electrode 115 conduct electricity, the electrode 113, the electrode 114, and the electrode 115 simultaneously feed the electric power provided by the battery cell 7 to the first infrared electric heating coating S1 and the second infrared electric heating coating S2. That is, the first infrared electric heating coating S1 and the second infrared electric heating coating S2 are equivalent to being connected in parallel between the electrode 113, the electrode 114, and the electrode 115. By means of the plurality of infrared electric heating coatings that are connected in parallel, a resistance of the infrared electric heating coating 112 can be reduced as a whole. Assuming that a current flows in from the electrode 113 and the electrode 115 and flows out from the electrode 114, a flow direction of the current on the infrared electric heating coating 112 basically extends in the axial direction of the base body 111 (as shown by a dashed arrow in the figure).

Different from the examples in FIG. 8 and FIG. 9, staged heating of the aerosol forming substrate may be implemented by controlling electricity conducting sequence of the electrode 113, the electrode 114, and the electrode 115. For example, the electrode 113 and the electrode 114 are first controlled to conduct electricity, and the first infrared electric heating coating S1 is activated to heat the aerosol forming substrate in an area corresponding to the first infrared electric heating coating S1. Subsequently, the electrode 114 and the electrode 115 are controlled to conduct electricity, and the second infrared electric heating coating S2 is activated to heat the aerosol forming substrate in an area corresponding to the second infrared electric heating coating S2.

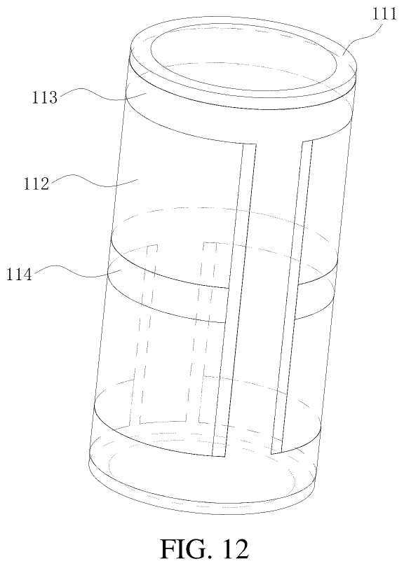

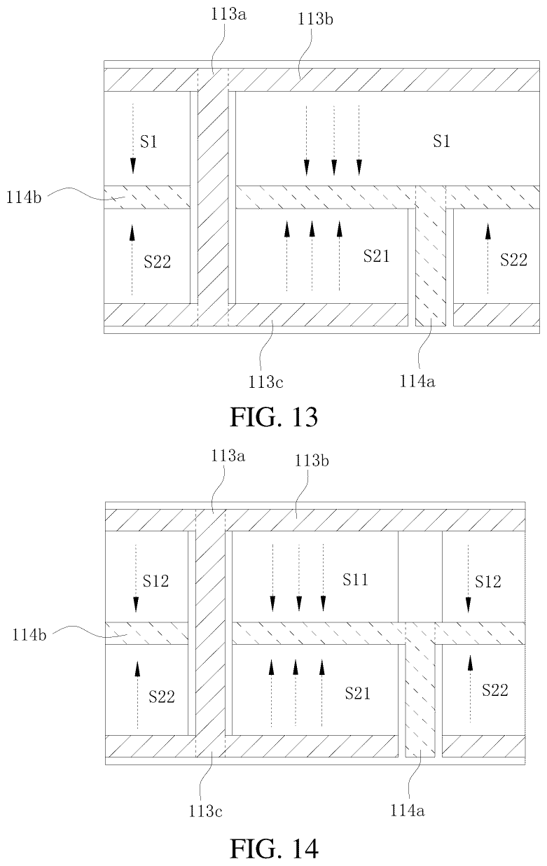

FIG. 12 and FIG. 13 show a heater according to a fifth example of this application.

In examples in FIG. 12 and FIG. 13, a size of the base body 111 may be designed to be applicable to a thick and short aerosol generating product or a thin and long aerosol generating product. Preferably, the base body 111 is designed according to a size applicable to a thick and short aerosol generating product, that is, an inside diameter of the base body 111 ranges from 6 mm to 15 mm, or ranges from 7 mm to 15 mm, or ranges from 7 mm to 14 mm, or ranges from 7 mm to 12 mm, or ranges from 7 mm to 10 mm. An axial extension length of the base body 111 ranges from 15 mm to 30 mm, or ranges from 15 mm to 28 mm, or ranges from 15 mm to 25 mm, or ranges from 16 mm to 25 mm, or ranges from 18 mm to 25 mm, or ranges from 18 mm to 24 mm, or ranges from 18 mm to 22 mm.

In the examples in FIG. 12 and FIG. 13, the infrared electric heating coating 112 includes a first infrared electric heating coating S1 and a second infrared electric heating coating S2, and the second infrared electric heating coating S2 is separated into an infrared electric heating coating S21 and an infrared electric heating coating S22.

The electrode 113 includes an electrode 113a that extends in an axial direction of the base body 111 and that has a strip shape, and electrodes 113b and 113c that extend in a peripheral direction of the base body 111 and that have an arc shape.

Similar to the examples in FIG. 3 and FIG. 4, the electrode 113a is spaced apart from the first infrared electric heating coating S1 and the second infrared electric heating coating S2. One end of the electrode 113a is arranged close to the near end of the base body 111, and the other end of the electrode 113a is arranged close to the far end of the base body 111. The electrode 113b is arranged close to the near end of the base body 111. The electrode 113b starts from the electrode 113a, extends in the peripheral direction of the base body 111, and ends at the electrode 113a. A peripheral extension length of the electrode 113b is greater than a peripheral extension length of the first infrared electric heating coating S1. The electrode 113b maintains in contact with the first infrared electric heating coating S1 to form an electrical connection.

Different from examples in FIG. 3 and FIG. 4, the electrode 113c is arranged close to the far end of the base body 111.

Similar to the example in FIG. 3 and FIG. 4, the electrode 113c starts from the electrode 113a, a part of the electrode 113c extends in a first peripheral direction, for example, a clockwise direction, of the base body 111, and is arranged close to the electrode 114. This part of the electrode 113c maintains in contact with the infrared electric heating coating S22 to form an electrical connection. Another part of the electrode 113c extends in a second peripheral direction, for example, an anticlockwise direction, of the base body 111, and is arranged close to the electrode 114. This another part of the electrode 113c maintains in contact with the infrared electric heating coating S21 to form an electrical connection.

The electrode 114 includes an electrode 114a that extends in an axial direction of the base body 111 and that has a strip shape, and an electrode 114b that extends in a peripheral direction of the base body 111 and that has an arc shape.

Similar to the examples in FIG. 3 and FIG. 4, the electrode 114a is spaced apart from the second infrared electric heating coating S2. The electrode 114a and the electrode 113a are spaced apart, that is, arranged on two sides of the infrared electric heating coatings S21. An axial extension length of the electrode 114a is less than an axial extension length of the electrode 113a. One end of the electrode 114a is arranged close to the first infrared electric heating coating S1. Preferably, one end of the electrode 114a maintains in contact with the first infrared electric heating coating S1; and the other end of the electrode 114a is arranged close to the far end of the base body 111.

Similar to the examples in FIG. 3 and FIG. 4, the electrode 114b is arranged between the first infrared electric heating coating S1 and the second infrared electric heating coating S2. The electrode 114b starts from the electrode 114a, a part of the electrode 114b extends in a first peripheral direction, for example, a clockwise direction, of the base body 111, and is arranged close to the electrode 113a. This part of the electrode 114b maintains in contact with the infrared electric heating coating S1 and the infrared electric heating coating S21 to form an electrical connection. Another part of the electrode 114b extends in a second peripheral direction, for example, an anticlockwise direction, of the base body 111, and is arranged close to the electrode 113a. This another part of the electrode 114b maintains in contact with the infrared electric heating coating S1 and the infrared electric heating coating S22 to form an electrical connection.

Similar to the examples in FIG. 3 and FIG. 4, after the electrode 113 and the electrode 114 conduct electricity, the electrode 113 and the electrode 114 simultaneously feed the electric power provided by the battery cell 7 to the first infrared electric heating coating S1, the infrared electric heating coating S21, and the infrared electric heating coating S22. That is, the first infrared electric heating coating S1, the infrared electric heating coating S21, and the infrared electric heating coating S22 are equivalent to being connected in parallel between the electrode 113 and the electrode 114. By means of the plurality of infrared electric heating coatings that are connected in parallel, a resistance of the infrared electric heating coating 112 can be reduced as a whole. Assuming that a current flows in from the electrode 113 and flows out from the electrode 114, a flow direction of the current on the infrared electric heating coating 112 basically extends in the axial direction of the base body 111 (as shown by a dashed arrow in the figure).

Similar to the examples in FIG. 3 and FIG. 4, an arrangement of the electrode 113 and the electrode 114 facilitates routing with the battery cell 7. The resistance of the infrared electric heating coating 112 may be reduced as a whole. Power distribution of each area may be adjusted by adjusting an equivalent resistance of each infrared electric heating coating, so as to adjust temperature distribution of each area.

FIG. 14 shows a heater according to a sixth example of this application.

Different from examples in FIG. 12 and FIG. 13: The first infrared electric heating coating S1 is separated into an infrared electric heating coating S11 and an infrared electric heating coating S12.

Similar to the examples in FIG. 12 and FIG. 13, a resistance of the infrared electric heating coating 112 may be further reduced as a whole.

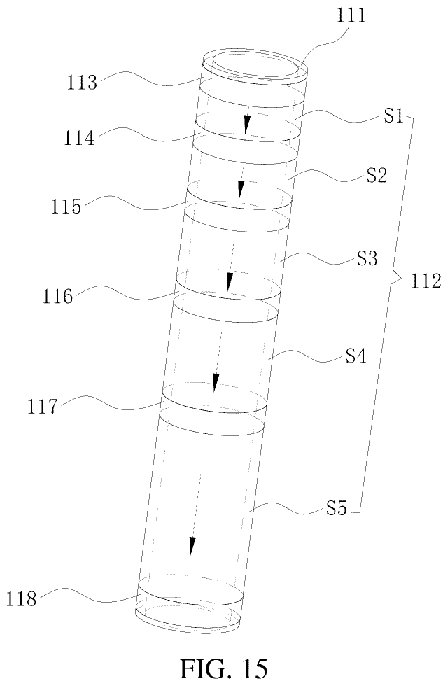

FIG. 15 shows a heater according to a seventh example of this application.

In an example in FIG. 15, the infrared electric heating coating 112 includes a first infrared electric heating coating S1, a second infrared electric heating coating S2, a third infrared electric heating coating S3, a fourth infrared electric heating coating S4, and a fifth infrared electric heating coating S5 that are sequentially arranged in an axial direction of the base body 111.

In the example in FIG. 15, the electrically conductive element includes an electrode 113, an electrode 114, an electrode 115, an electrode 116, an electrode 117, and an electrode 118 that are spaced apart on the base body 111.

The electrode 113 is arranged close to a near end of the base body 111 and maintains in contact with the first infrared electric heating coating S1 to form an electrical connection.

The electrode 114 maintains in contact with the first infrared electric heating coating S1 and the second infrared electric heating coating S2 to form an electrical connection.

The electrode 115 maintains in contact with the second infrared electric heating coating S2 and the third infrared electric heating coating S3 to form an electrical connection.

The electrode 116 maintains in contact with the third infrared electric heating coating S3 and the fourth infrared electric heating coating S4 to form an electrical connection.

The electrode 117 maintains in contact with the fourth infrared electric heating coating S4 and the fifth infrared electric heating coating S5 to form an electrical connection.

The electrode 118 maintains in contact with the fifth infrared electric heating coating S5 to form an electrical connection.

Staged heating of the aerosol forming substrate may be implemented by controlling an electricity conducting sequence of the electrode 113, the electrode 114, the electrode 115, the electrode 116, the electrode 117, and the electrode 118.

For example: the electrode 113 may be first controlled to be conducted with a positive electrode of the battery cell 7, and then the electrode 114, the electrode 115, the electrode 116, the electrode 117, and the electrode 118 may be sequentially controlled to be conducted with a negative electrode of the battery cell 7 one by one. In this way, when the electrode 113 and the electrode 114 are conducted with the battery cell 7, the first infrared electric heating coating S1 starts to heat; when the electrode 113 and the electrode 115 are conducted with the battery cell 7 (the electrode 114 is disconnected from the battery cell 7), the first infrared electric heating coating S1 and the second infrared electric heating coating S2 start to heat; when the electrode 113 and the electrode 116 are conducted with the battery cell 7 (the electrode 114 and the electrode 115 are disconnected from the battery cell 7), the first infrared electric heating coating S1, the second infrared electric heating coating S2, and the third infrared electric heating coating S3 start to heat; when the electrode 113 and the electrode 117 are conducted with the battery cell 7 (the electrode 114, the electrode 115, and the electrode 116 are disconnected from the battery cell 7), the first infrared electric heating coating S1, the second infrared electric heating coating S2, the third infrared electric heating coating S3, and the fourth infrared electric heating coating S4 start to heat; and when the electrode 113 and the electrode 118 are conducted with the battery cell 7 (the electrode 114, the electrode 115, the electrode 116, and the electrode 117 are disconnected from the battery cell 7), the first infrared electric heating coating S1, the second infrared electric heating coating S2, the third infrared electric heating coating S3, the fourth infrared electric heating coating S4, and the fifth infrared electric heating coating S5 start to heat.

For another example: the electrode 113 and the electrode 114 may be first controlled to be conducted with the battery cell 7, so that the first infrared electric heating coating S1 starts to heat; and if the electrode 113 and the electrode 114 are conducted with the battery cell 7, the electrode 115 is then controlled to be electrically connected the battery cell 7, so that the first infrared electric heating coating S1 and the second infrared electric heating coating S2 start to heat. In this sequence, until all the electrodes are conducted with the battery cell 7.

For another example: the electrode 113 and the electrode 114 may be first controlled to be conducted with the battery cell 7, so that the first infrared electric heating coating S1 starts to heat; Then, the electrode 114 and the electrode 115 are controlled to be conducted with the battery cell 7 (the electrode 113 is disconnected from the battery cell 7), and the second infrared electric heating coating S2 starts to heat; and in this sequence, until the electrode 117 and the electrode 118 are controlled to be conducted with the battery cell 7.

It is to be noted that, an electricity conducting sequence of the electrode 113, the electrode 114, the electrode 115, the electrode 116, the electrode 117, and the electrode 118 is not limited to the foregoing listed situations.

It is to be noted that, in an example in FIG. 15, a size of the base body 111 may be designed to be applicable to a thick and short aerosol generating product or a thin and long aerosol generating product, preferably, designed to be applicable to the thin and long aerosol generating product.

It is to be noted that, the specification of this application and the drawings thereof provide preferred embodiments of this application. However, this application may be implemented in various different forms, and is not limited to the embodiments described in this specification. These embodiments are not used as an additional limitation on the content of this application, and are described for providing a more thorough and comprehensive understanding of the content disclosed in this application. Moreover, various embodiments not listed above formed by further combining the foregoing technical features with each other are all construed as falling within the scope of this application. Further, for a person of ordinary skill in the art, improvements or modifications may be made according to the above descriptions, and all these improvements and modifications fall within the protection scope of the appended claims of this application.

1. A heater, configured to heat an aerosol forming substrate in an aerosol generation product to generate an aerosol, wherein the heater comprises:
a base body;
an electric heating film layer, arranged on a surface of the base body;
an electrically conductive element, configured to feed electric power to the electric heating film layer and cause a flow direction of a current on the electric heating film layer to extend in an axial direction of the base body,
wherein the electrically conductive element comprises at least one electrode extending in an axial direction of the base body, and the electrode and the electric heating film layer are spaced apart.

2. The heater according to claim 1, wherein the based body is configured as a tubular structure; and
an inner diameter of the base body ranges from 6 mm to 15 mm, and an axial extension length of the base body ranges from 15 mm to 30 mm.

3. The heater according to claim 1, wherein the base body is further provided with a positioning slot to position the base body.

4. The heater according to claim 1, wherein the electric heating film layer comprises an infrared electric heating coating configured to receive the electric power to generate heat to generate an infrared ray.

5. The heater according to claim 1, wherein the electric heating film layer comprises a plurality of electric heating film layers that are connected in parallel and that are spaced apart in the axial direction of the base body; and
the electrically conductive element is configured to simultaneously feed the electric power to the plurality of electric heating film layers to enable at least one flow direction of the current on the plurality of electric heating film layers extends in the axial direction of the base body.

6. The heater according to claim 5, wherein current flow directions on two adjacent electric heating film layers of the plurality of electric heating film layers are opposite.

7. The heater according to claim 5, wherein at least one of the plurality of electric heating film layers has a plurality of sub-electric heating film layers spaced apart in a peripheral direction of the base body.

8. (canceled)

9. The heater according to claim 5, wherein a resistance of at least one of the plurality of electric heating film layers is different from a resistance of another electric heating film layer.

10. The heater according to claim 5, wherein the base body comprises a near end and a far end; and
a resistance of an electric heating film layer among the plurality of electric heating film layers close to the near end of the base body is less than a resistance of another electric heating film layer.

11. The heater according to claim 5, wherein the electrically conductive element comprises a first electrode and a second electrode that are spaced apart, and the first electrode and the second electrode simultaneously feed the electric power to the plurality of electric heating film layers;
the first electrode comprises a third electrode extending in the axial direction of the base body and a fourth electrode extending in a peripheral direction of the base body, and the second electrode comprises a fifth electrode extending in the axial direction of the base body and a sixth electrode extending in the peripheral direction of the base body; and
the third electrode and the fifth electrode are spaced apart from the plurality of electric heating film layers, and the fourth electrode and the sixth electrode maintain in contact with the plurality of electric heating film layers to form electric connections.

12. The heater according to claim 11, wherein in the peripheral direction of the base body, the third electrode is arranged close to the fifth electrode, or the third electrode and the fifth electrode are arranged on two sides of a part of the electric heating film layer.

13. The heater according to claim 11, wherein an axial extension length of the third electrode is greater than an axial extension length of the fifth electrode.

14. The heater according to claim 11, wherein the base body comprises a near end and a far end; and
one end of the third electrode is arranged close to the near end of the base body, and the other end of the third electrode is arranged close to the far end of the base body; and one end of the fifth electrode is arranged close to the far end of the base body.

15. The heater according to claim 11, wherein the first electrode comprises a plurality of fourth electrodes, and the second electrode comprises one or more sixth electrodes; and
one sixth electrode is arranged between two adjacent fourth electrodes in the axial direction of the base body.

16. The heater according to claim 11, wherein the fourth electrode is configured to start from the third electrode, extend in the peripheral direction of the base body, and end with the third electrode; and/or, the fourth electrode is configured to start from the third electrode, extend in the peripheral direction of the base body, and to be arranged close to the fifth electrode.

17. The heater according to claim 11, wherein the sixth electrode is configured to start from the third electrode, extend in the peripheral direction of the base body, and to be arranged close to the third electrode.

18. The heater according to claim 11, wherein the electrically conductive element further comprises a seventh electrode, and the first electrode, the second electrode, and the seventh electrode simultaneously feed the electric power to the plurality of electric heating film layers; and
the seventh electrode is configured to extend in the peripheral direction of the base body and to maintain in contact with at least one of the plurality of electric heating film layers to form electric connections.

19. The heater according to claim 11, wherein the third electrode and the fifth electrode are configured as strip electrodes that extend in the axial direction of the base body;
and/or, the fourth electrode and the sixth electrode are configured as arc electrodes that extend in the peripheral direction of the base body.

20. A manufacturing method for the heater according to claim 1, wherein spacing between the electrode and the electric heating film layer is implemented by at least one of the following:
applying the electrically conductive element and the electric heating film layer to a surface of the base body, and then removing a part of the electric heating film layer close to the electrode from the coated electric heating film layer;
first, applying the electric heating film layer to the surface of the base body, then, removing the electric heating film layer from a part of the surface, and finally, applying the electrically conductive element to the part of the surface;
partially applying the electrically conductive element to a first part of the surface of the base body, and completely applying the electric heating film layer on a second part of the surface of the base body; or, completely applying the electrically conductive element to the first part of the surface of the base body, and partially applying the electric heating film layer to the second part of the surface of the base body; or, partially applying the electrically conductive element to the first part of the surface of the base body, and partially applying the electric heating film layer to the second part of the surface of the base body; and
applying the electrically conductive element to the first part of the surface of the base body, and applying the electric heating film layer to the second part of the surface of the base body, wherein the first part of the surface and the second part of the surface are spaced apart.

21. An aerosol generating device, comprising:
a housing assembly;
the heater according to claim 1, wherein the heater is arranged in the housing assembly; and
a battery cell, configured to provide electric power.
